(19) United States
(12) Patent Application Publication
(10) Pub. No.: US 2011/0316941 A1
(43) Pub. Date: Dec. 29, 2011

(54) Ink path structure and inkjet head including the same

(75) Inventors: Hyun Ho Shin, Yongin (KR); Sung Wook Kim, Suwon (KR); Seung Mo Lim, Suwon (KR); Suk Ho Song, Ansan (KR); Chang Sung Park, Suwon (KR); Pil Joong Kang, Jinju (KR)

(73) Assignee: SAMSUNG ELECTRO-MECHANICS CO., LTD., Suwon (KR)

(21) Appl. No.: 12/929,171

(22) Filed: Jan. 5, 2011

(30) Foreign Application Priority Data
Jun. 23, 2010 (KR) 10-2010-0059615

(51) Int. Cl. B41J 2/175

(52) U.S. Cl. 347/85

(57) ABSTRACT

There is provided an ink path structure, including: a pressure chamber storing ink introduced thereinto to discharge the ink to a nozzle; and a path discharging the ink by pressure generated within the pressure chamber and then supplying the ink to the pressure chamber and being repeatedly expanded and contracted in a direction toward the pressure chamber to attenuate a residual pressure wave remaining in the pressure chamber.

### CROSS-REFERENCE TO RELATED APPLICATIONS

This application claims the priority of Korean Patent Application No. 10-2010-0059615 filed on Jun. 23, 2010, in the Korean Intellectual Property Office, the disclosure of which is incorporated herein by reference.

### BACKGROUND OF THE INVENTION

1. Field of the Invention

The present invention relates to an ink path structure and an inkjet head including the same, and more particularly, to an ink path structure in which a structure of a path configuring a manifold is changed so as to attenuate a residual pressure wave remaining after discharging ink, and an inkjet head including the same.

2. Description of the Related Art

Generally, an inkjet head has a structure that converts an electrical force into a physical force to discharge ink in a droplet type through a small nozzle.

The inkjet head may be largely classified into two types according to ink discharge type. One is a thermal driving type inkjet head that uses a heat source to generate bubbles and discharges ink by an expansion force of the bubble, while the other is a piezoelectric type inkjet head that uses a piezoelectric material to discharge ink depending on pressure applied to the ink due to deformation in the piezoelectric material.

In particular, the piezoelectric type inkjet head has been prevalently used recently in an industrial inkjet printer. For example, the inkjet head has been used to directly form circuit patterns by jetting ink made by melting metals, such as gold, silver, or the like, on a flexible printed circuit board (FPCB) or to manufacture industrial graphics, a liquid crystal display (LCD), an organic light emitting diode (OLED), a solar cell, or the like.

The piezoelectric type inkjet head includes an actuator made of a piezoelectric material so as to discharge ink in a pressure chamber to the outside through a nozzle. In this case, a pressure wave generated from the actuator is propagated to the nozzle to discharge ink.

However, the generated pressure wave is not completely dissipated even after a droplet is discharged. Therefore, the pressure wave overlaps with subsequent pressure waves at the time of discharging a droplet, thereby causing the abnormal discharge of a droplet.

In other words, after a pressure wave for discharging a droplet discharges ink, it remains in a pressure chamber storing ink, thereby affecting the discharge of a subsequent droplet.

In particular, when a discharging frequency by the actuator rises to a predetermined frequency or more, the effect of the residual pressure wave is more serious, thereby making the discharged droplet rate unstable.

Therefore, research into the removal of the residual pressure wave remaining in the pressure chamber within a short time after a droplet is discharged so as to stably discharge ink is urgently needed.

### SUMMARY OF THE INVENTION

An aspect of the present invention provides an ink path structure capable of improving ink discharge characteristics by attenuating a residual pressure wave remaining in a pressure chamber within a short time and an inkjet head including the same.

According to an aspect of the present invention, there is provided an ink path structure, including: a pressure chamber storing ink introduced thereinto to discharge the ink to a nozzle; and a path discharging the ink by pressure generated within the pressure chamber and then supplying the ink to the pressure chamber and being repeatedly expanded and contracted in a direction toward the pressure chamber to attenuate a residual pressure wave remaining in the pressure chamber.

The path may be formed to have a plurality of lines corresponding to the pressure chamber to supply the ink to the pressure chamber.

The path may be formed by communicating a plurality of path units with each other, the path unit including a sectional area expanding part whose sectional area is gradually expanded in a direction towards the pressure chamber and a sectional area contracting part whose sectional area is gradually contracted at one end of the sectional area expanding part.

The sectional area expanding part and the sectional area contracting part may be disposed to be symmetrical to each other based on the boundary therebetween.

The path may be formed by disposing the path units in a path direction in series and communicating them with each other.

According to another aspect of the present invention, there is provided an inkjet head, including: a pressure chamber storing ink introduced thereinto to discharge the ink to a nozzle; an actuator positioned at an outer surface corresponding to the pressure chamber to provide a discharging driving force of the ink to the pressure chamber; and a manifold including a path discharging the ink by pressure generated within the pressure chamber generated by the actuator and then supplying the ink to the pressure chamber and being repeatedly expanded and contracted in a direction toward the pressure chamber to attenuate a residual pressure wave remaining in the pressure chamber.

The path may be formed to have a plurality of lines corresponding to the pressure chamber to supply the ink to the pressure chamber.

The path may be formed by communicating a plurality of path units with each other, the path unit including a sectional area expanding part whose sectional area is gradually expanded in a direction towards the pressure chamber and a sectional area contracting part whose sectional area is gradually contracted at one end of the sectional area expanding part.

The sectional area expanding part and the sectional area contracting part may be disposed to be symmetrical to each other based on the boundary therebetween.

The path may be formed by disposing the path units in a path direction in series and communicating them with each other.

According to another aspect of the present invention, there is provided an inkjet head, including: an upper substrate formed with a pressure chamber storing ink introduced thereinto to discharge the ink to a nozzle; an actuator positioned at one surface of the upper substrate corresponding to the pressure chamber to provide a discharging driving force of the ink to the pressure chamber; a lower substrate including a nozzle communicating with the pressure chamber and formed for discharging the ink; and a manifold formed on the upper substrate and including a path discharging the ink by pressure generated within the pressure chamber generated by the actuator and then supplying the ink to the pressure chamber and being repeatedly expanded and contracted in a direction toward the pressure chamber to attenuate a residual pressure wave remaining in the pressure chamber.

The path may be formed to have a plurality of lines corresponding to the pressure chamber to supply the ink to the pressure chamber.

The path may be formed by communicating a plurality of path units with each other, the path unit including a sectional area expanding part whose sectional area is gradually expanded in a direction towards the pressure chamber and a sectional area contracting part whose sectional area is gradually contracted at one end of the sectional area expanding part.

The sectional area expanding part and the sectional area contracting part maybe disposed to be symmetrical to each other based on the boundary therebetween.

The path may be formed by disposing the path units in a path direction in series and communicating them with each other.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view showing a partially cutaway inkjet head according to an exemplary embodiment of the present invention;

FIG. 2 is a perspective view schematically showing one unit in the inkjet head according to the exemplary embodiment of the present invention;

FIG. 3 is an exploded perspective view schematically showing one unit in the inkjet head according to the exemplary embodiment of the present invention;

FIG. 4 is a cross-sectional view schematically showing one unit in the inkjet head according to the exemplary embodiment of the present invention, in particular, a cross-sectional view taken along line A-A of FIG. 1;

FIG. 5 is an exploded perspective view schematically showing an ink path structure provided in the inkjet head according to the exemplary embodiment of the present invention;

FIG. 6 is a plan view schematically showing the ink path structure provided in the inkjet head according to the exemplary embodiment of the present invention;

FIG. 7 is a graph showing a change in a residual pressure wave within a pressure chamber of the ink path structure provided in the inkjet head according to the exemplary embodiment of the present invention; and

FIGS. 8A to 8C are plan views schematically showing a path provided in the ink path structure according to the exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the exemplary embodiments set forth herein and those skilled in the art and understanding the present invention can easily accomplish retrogressive inventions or other exemplary embodiments included in the spirit of the present invention by the addition, modification, and removal of components within the same spirit, but those are construed as being included in the spirit of the present invention.

In addition, components having like functions are denoted by like reference numerals throughout the drawings of each exemplary embodiment.

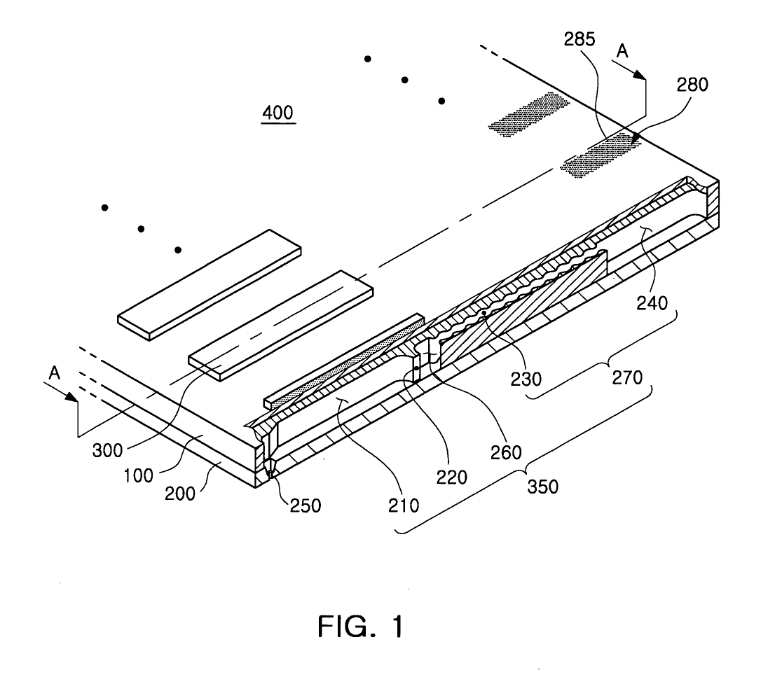

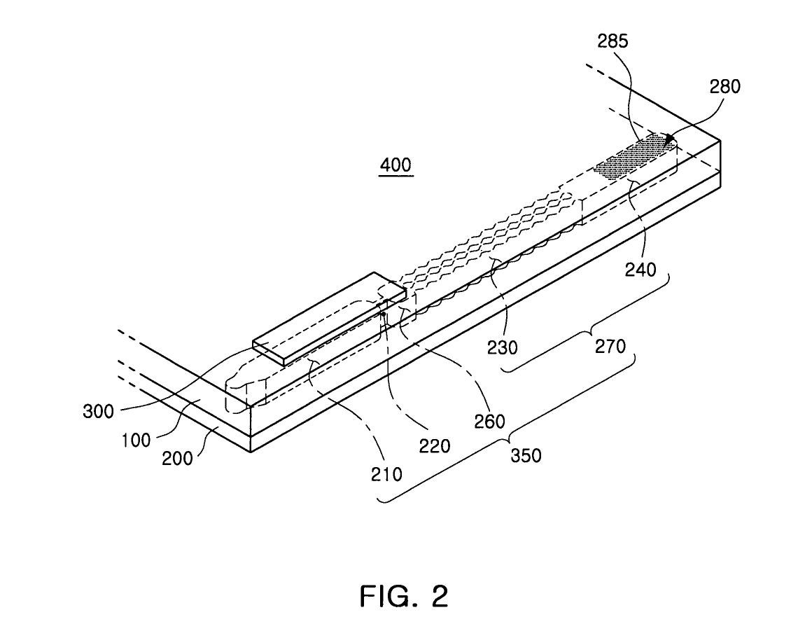

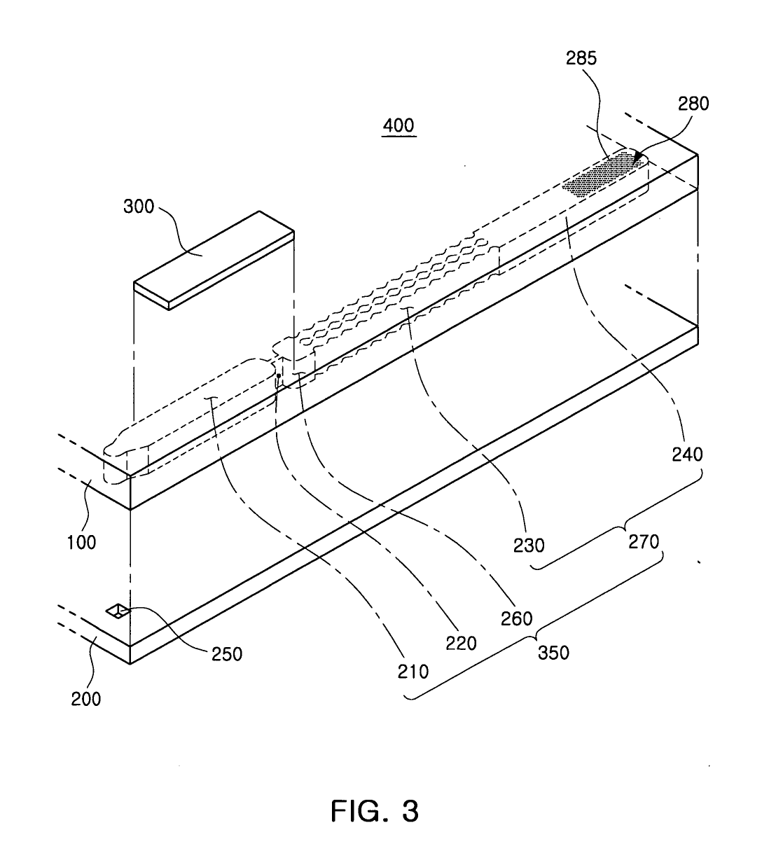

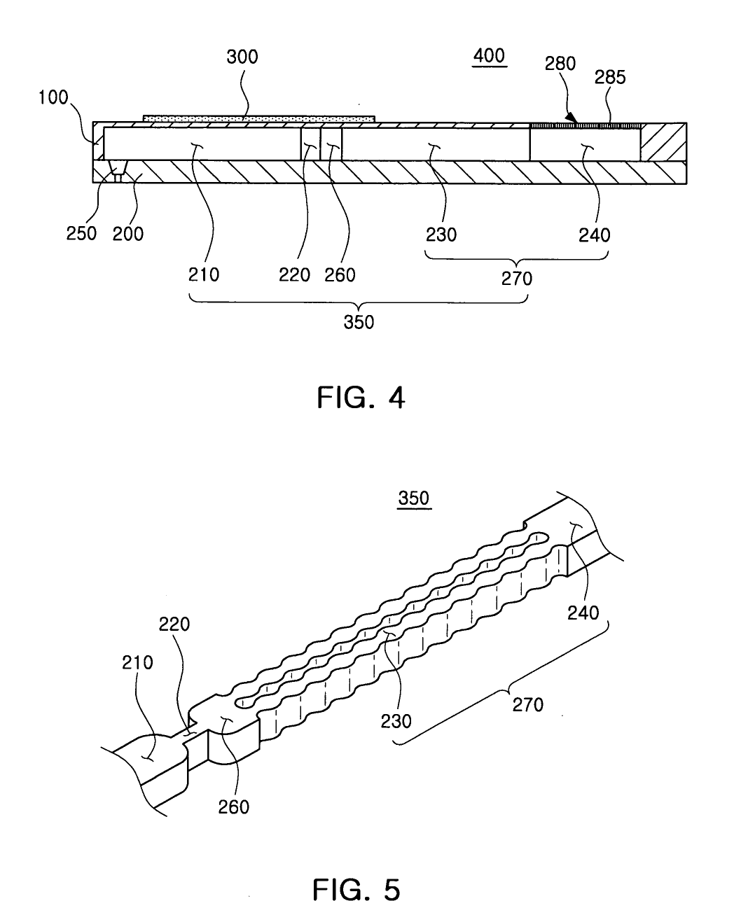

FIG. 1 is an exploded perspective view showing a partially cutaway inkjet head according to an exemplary embodiment of the present invention, FIG. 2 is a perspective view schematically showing one unit in the inkjet head according to the exemplary embodiment of the present invention, FIG. 3 is an exploded perspective view schematically showing one unit in the inkjet head according to the exemplary embodiment of the present invention, and FIG. 4 is a cross-sectional view schematically showing one unit in the inkjet head according to the exemplary embodiment of the present invention, in particular, a cross-sectional view taken along line A-A of FIG. 1.

Referring to FIGS. 1 to 4, an inkjet head 400 according to an exemplary embodiment of the present invention may include an upper substrate 100, a lower substrate 200, an ink path structure 350 formed in the upper substrate 100, and an actuator 300.

The upper substrate 100 is regularly provided with a plurality of pressure chambers 210 and an ink inlet 280 into which ink is introduced. In this configuration, the ink inlet 280 is configured to be directly connected to a manifold 270 and the manifold 270 serves to supply ink to the pressure chamber 210 through a restrictor 220.

The ink inlet 280 serves to supply ink introduced from an ink reservoir (not shown) to the manifold 270. Herein, although the ink inlet 280 may be formed in a plurality, corresponding to the plurality of manifolds 270, a single ink inlet 280 may be formed to communicate with the plurality of manifolds 270.

In this case, when the ink inlets 280 are each formed to correspond to the plurality of manifolds 270, the ink inlets 280 formed in each manifold 270 may be formed of an assembly of lots of holes 285 having a very small diameter.

This may serve as a filter preventing foreign objects from being introduced into the inkjet head 400 by forming the ink inlet 280 into the holes 285 having a very small diameter.

In addition, the pressure chamber 210 may be provided under a position in which the actuator 300 is mounted. In this configuration, a portion forming a ceiling of the pressure chamber 210 in the upper substrate 100 serves as a membrane.

Therefore, when driving signals are applied to the actuator 300 in order to discharge ink, the volume of the pressure chamber 210 is reduced while the actuator 300 and the membrane thereunder are deformed.

As a result, the ink in the pressure chamber 210 is discharged to the outside through a damper and a nozzle configuring a nozzle part 250 by the increase in pressure within the pressure chamber 210.

The upper substrate 100 may use a silicon on insulator (SOI) substrate on which an intermediate oxide layer serving as an etch stop layer is formed, in order to accurately set the height of the pressure chamber 210.

In this configuration, the manifold 270 may include a reservoir 240 that is supplied with and stores ink from the ink inlet 280, and a path 230 that is connected to the restrictor 220.

In other words, in order to supply the ink to the pressure chamber 210, the ink should pass through the path 230 configuring the manifold 270.

After the ink passing through the path 230 passes through the restrictor 220 and reaches the pressure chamber 210, it may be discharged to the outside by the driving force of the actuator 300.

However, a connection part 260 may be provided between the path 230 and the restrictor 220, which is not an essential component.

The nozzle part 250 receives ink discharged from the pressure chamber 210 by the actuator 300 and discharges it to the outside.

In other words, the ink is discharged to the outside through the damper and the nozzle configuring the nozzle part 250.

In this configuration, when the damper configuring the nozzle part 250 is manufactured by wet etching, it may be manufactured in a trapezoidal form, and when the lower substrate 200 is manufactured as the silicon on insulator (SOI) substrate, a cylindrical damper manufactured by a dry etching may also be manufactured.

However, the shape of the damper is not limited to the above-mentioned shape and may be changed by those skilled in the art and understanding the spirit of the present invention.

In this configuration, the nozzle part 250 is formed on the lower substrate 200 to jet ink moving through the path formed within the inkjet head 400 as a droplet.

In this configuration, the lower substrate 200 may use a silicon substrate prevalently used for a semiconductor integrated circuit, but is not necessarily limited to the silicon substrate. As a result, the lower substrate 200 may use various materials.

The actuator 300 may include a piezoelectric material and the ink may be discharged to the outside through the nozzle part 250 formed on the lower substrate 200 due to the deformation in the piezoelectric material.

In other words, the piezoelectric material deforms the upper surface of the pressure chamber 210, i.e., the membrane to generate the driving force for discharging the ink. When voltage is applied to the piezoelectric material, the driving force is transferred in a vertical direction due to the vertical deformation in the membrane. The ink within the pressure chamber may be discharged to the outside through the nozzle part 250 by the driving force.

In this configuration, the piezoelectric material is an element that can convert electrical energy into mechanical energy or vice versa. An example of the material may include lead zirconate titanate (Pb (Zr, Ti) O3: PZT), a ceramic, or the like.

In addition, a bubble jet type and a thermal jet type may be used, in addition to the piezoelectric type using the piezoelectric material for discharging ink.

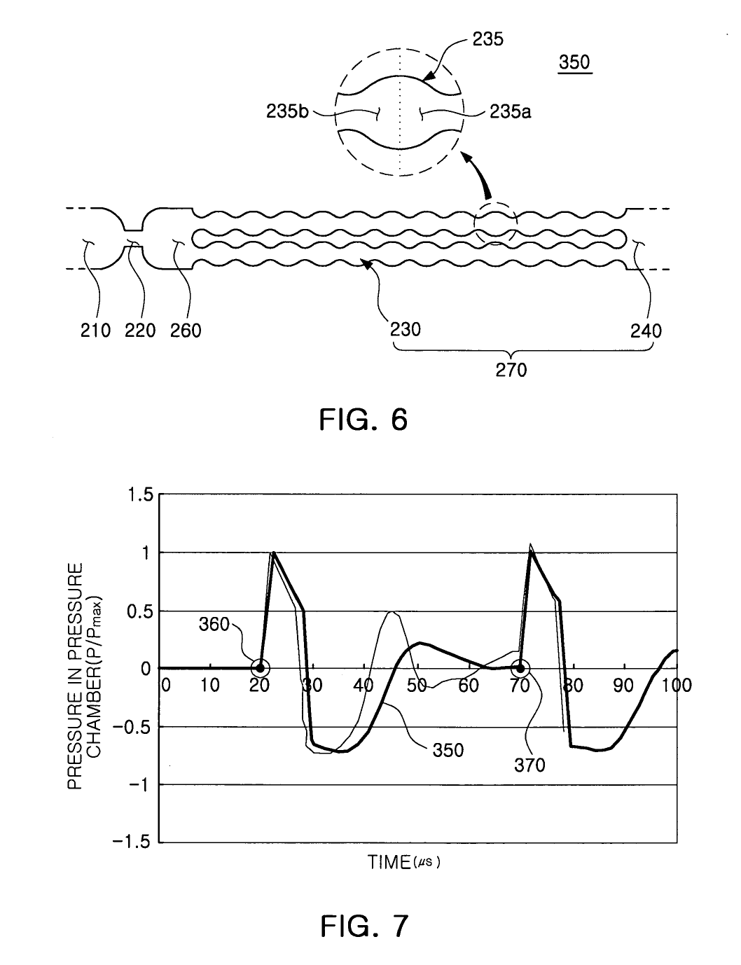

FIG. 5 is an exploded perspective view schematically showing an ink path structure provided in the inkjet head according to the exemplary embodiment of the present invention, FIG. 6 is a plan view schematically showing the ink path structure provided in the inkjet head according to the exemplary embodiment of the present invention, and FIG. 7 is a graph showing a change in a residual pressure wave within a pressure chamber of the ink path structure provided in the inkjet head according to the exemplary embodiment of the present invention.

Referring to FIGS. 5 and 6, the inkjet path structure 350 provided in the inkjet head according to the exemplary embodiment of the present invention may include the pressure chamber 210, the restrictor 220, and the manifold 270.

In this configuration, the pressure chamber 210 serves to discharge ink to the outside by the change in pressure within the pressure chamber 210 and has the same components and effects as the exemplary embodiment and therefore, a description thereof will be omitted.

The manifold 270 may include the reservoir 240 that is supplied with and stores ink from the ink inlet 280 and the path 230 that is connected to the restrictor 220.

The path 230 is a pipe supplying ink to the pressure chamber 210 through the restrictor 220 and may include an inner space that is repeated expanded and contracted in a direction toward the pressure chamber 210.

In other words, the passage 230 may include a sectional area that is repeatedly expanded and contracted in a direction toward the pressure chamber 210.

In other words, the path 230 may be formed by connecting the plurality of path units 235 to each other, wherein the path unit 235 includes a sectional area expanding part 235a whose sectional area is gradually expanded and a sectional area contracting part 235b whose sectional area is gradually contracted at one end of the sectional area expanding part 235a.

In this configuration, the path units 235 are arranged in series in a path direction and communicate with each other to configure the paths 230 and may communicate with each other equidistantly.

The path 230 configured as described above is formed to have a plurality of lines to supply the ink to the pressure chamber 210.

However, the path 230 is preferably formed to have two lines, but is not necessarily limited thereto and therefore, may be changed by those skilled in the art.

Generally, the performance of the inkjet head 400 becomes a problem when a high frequency is applied by the actuator 300. In other words, it is the high frequency discharging characteristic of the inkjet head 400 that is a very important factor to determine the performance of the inkjet head.

The inkjet head 400 discharges a droplet by discharging a head portion of the droplet out of the nozzle part 250 at a positive pressure of the pressure wave and cutting a tail portion of the droplet at a negative pressure thereof, after the pressure wave generated from the actuator 300 is propagated to the nozzle part 250.

However, the generated pressure wave is not immediately dissipated and propagated and reflected through and from the ink path structure 350 including the pressure chamber 210. That is, the pressure wave completely disappears by being dissipated only after a predetermined time elapses.

In this case, the pressure wave remaining in the ink path structure 350 including the pressure chamber 210 is defined as the residual pressure wave. It is the dissipation of the residual pressure wave that is an important factor in determining the performance of the inkjet head 400.

That is, the dissipation of the residual pressure wave determines the high-frequency driving stability of the inkjet head 400.

In other words, a droplet is discharged by the pressure wave generated by allowing a pulse applied from an external power supply for discharging the droplet to drive the piezoelectric material of the actuator 300 and the pressure wave is completely dissipated before the subsequent pulse for discharging the subsequent droplet is applied, thereby accomplishing the high-performance inkjet head 400.

However, if there is the residual pressure wave not being completely dissipated before the subsequent pulse is applied, the residual pressure wave overlaps with the pressure wave of the subsequent pulse to abnormally discharge a droplet.

Although most of the residual pressure waves in the entire waveform are dissipated in a low frequency region (in a range of 5 kHz or less) to exhibit the stable discharging characteristics, the residual pressure wave overlaps with the subsequently applied pressure wave in the high frequency region, thereby leading to a problem in discharging ink.

In particular, when the interface between the nozzle parts 250 is unstable due to the residual pressure wave, the droplet discharging characteristics are further unstable.

However, the ink path structure 350 provided in the inkjet head 400 according to the exemplary embodiment of the present invention includes the path 230 whose sectional area is repeatedly expanded and contracted, thereby making it possible to dissipate the residual pressure wave before the pressure wave of the subsequent pulse is applied.

FIG. 7 dimensionlessly shows the pressure in the pressure chamber 210 over time. The change in pressure when the path unit 235 is not provided is shown by a thin solid line and the change in pressure when the path unit 235 is provided is shown by a thick solid line (the ink path structure 350 of the present invention). This experimental results are analyzed by using a thermofluid analyzing program, Fluent

It can be appreciated that the ink path structure 350 according to the present invention is applied with a pulse 360 for discharging ink and completely dissipates 370 the residual pressure wave due to the previous pulse 360 before the subsequent pulse is applied.

That is, when ink is discharged at 20 KHz, the interval between the pulses is 50 μs. In this case, the residual pressure wave due to the pulse 360 first applied at 20 μs is completely dissipated 370 at 70 μs, such that the high-performance inkjet head 400 may be accomplished.

Further, the ink path structure 350 may includes the restrictor 220 between the path configuring the manifold 270 and the pressure chamber 210.

The sectional chamber of the restrictor 220 may be smaller than that of the pressure chamber 210 and the ink discharging performance may be varied according to the width and length of the sectional area of the restrictor 220.

However, when the width of the path of the restrictor 220 is greatly reduced, the residual pressure wave can be efficiently reduced but a flowing resistance is increased, such that the supply of ink from the manifold 270 to the pressure chamber 210 is very slow in the high frequency region.

Therefore, the width of the path of the restrictor 220 should be controlled to supply ink from the manifold 270 to the pressure chamber 210 and attenuate the above-mentioned residual pressure wave.

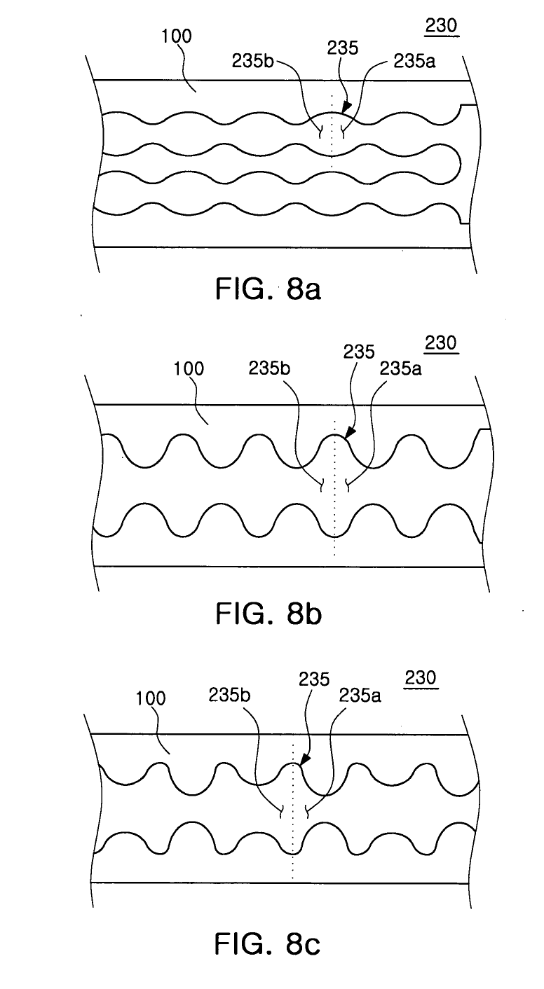

The path 230 will be described below with reference to FIGS. 8A to 8C.

FIGS. 8A to 8C are plan views schematically showing a path provided in the ink path structure according to the exemplary embodiment of the present invention.

Referring to FIGS. 8A to 8C, the path 230 provided in the ink path structure 350 according to the exemplary embodiment of the present invention may include the plurality of path units 235.

The path unit 235 is a unit configuring the path 230 including the sectional area expanding part 235a and the sectional area contracting part 235b, wherein the sectional area expanding part 235a is a portion in which the sectional area is increased in the direction from the reservoir 240 to the pressure chamber 210 and the sectional area contracting part 235b is a portion in which the sectional area is reduced from one end of the sectional area expanding part 235a.

The path unit 235 may be formed in two lines as shown in FIG. 8A, but is not necessarily not limited thereto and may be formed in one line as shown in FIGS. 8B and 8C.

Therefore, the manifold 230 is formed by disposing the path units 235 equidistantly and communicating them with each other. The path unit 235 is preferably formed in about 13 but is not necessarily limited thereto and may be changed by those skilled in the art.

In addition, as shown in FIGS. 8A and 8B, the sectional area expanding part 235a and the sectional area contracting part 235b of the path unit 235 may be formed to be symmetrical to each other based on the boundary therebetween, but may be formed to be asymmetrical to each other as shown in FIG. 8C.

In this case, the path structure 230 formed of the path unit 235 acoustically serves as a low-pass filter, which passes a low frequency but attenuates and interrupts a high frequency.

In other words, the path structure rapidly serves to remove a high frequency component in which pressure sharply increases instantly, such as a pressure peak, and converts it into a low frequency component in a smooth form.

Therefore, the path structure dissipates the residual pressure wave in the high frequency region within a short time, thereby making it possible to improve the high-frequency discharging characteristic of the inkjet head 400.

This can rapidly attenuate the residual pressure wave by periodically contracting and expanding the pattern of the inner wall surface and the space of the path 230.

In addition, the path 230 formed of the path unit 235 reduces the probability of the generation of bubbles at the time of the introduction of ink and can efficiently discharge ink preventing the adhesion of bubbles to the inner wall surface of the path 230, even though bubbles are generated.

As described above, the ink path structure 350 is formed by using the path 230 connected by communicating the plurality of path units 235 including the sectional area expanding part 235a and the sectional area contracting part 235b to attenuate the residual pressure wave, thereby making it possible to improve the high-frequency discharging characteristic of the inkjet head 400.

In addition, the ink path structure 350 secures the sectional area of the path 230 configuring the manifold 270, thereby making it possible to smoothly supply ink to the pressure chamber 210 and to reduce the bubble generation frequency at the time of the introduction of ink.

As set forth above, according to the ink path structure and the inkjet head including the same according to the present invention, the residual pressure wave remaining in the pressure chamber is attenuated within a short time, thereby making it possible to improve the ink discharging characteristics.

In addition, the present invention secures the path sectional area of the manifold, thereby making it possible to smoothly supply ink to the pressure chamber.

Further, the present invention can reduce the generation frequency of the bubbles at the time of introducing ink into the pressure chamber.

While the present invention has been shown and described in connection with the exemplary embodiments, it will be apparent to those skilled in the art that modifications and variations can be made without departing from the spirit and scope of the invention as defined by the appended claims.

What is claimed is:

1. An ink path structure, comprising:
a pressure chamber storing ink introduced thereinto to discharge the ink to a nozzle; and
a path discharging the ink by pressure generated within the pressure chamber and then supplying the ink to the pressure chamber and being repeatedly expanded and contracted in a direction toward the pressure chamber to attenuate a residual pressure wave remaining in the pressure chamber.

2. The ink path structure of claim 1, wherein the path is formed to have a plurality of lines corresponding to the pressure chamber to supply the ink to the pressure chamber.

3. The ink path structure of claim 1, wherein the path is formed by communicating a plurality of path units with each other, the path unit including a sectional area expanding part whose sectional area is gradually expanded in a direction towards the pressure chamber and a sectional area contracting part whose sectional area is gradually contracted at one end of the sectional area expanding part.

4. The ink path structure of claim 3, wherein the sectional area expanding part and the sectional area contracting part are disposed to be symmetrical to each other based on the boundary therebetween.

5. The ink path structure of claim 3, wherein the path is formed by disposing the path units in a path direction in series and communicating them with each other.

6. An inkjet head, comprising:
a pressure chamber storing ink introduced thereinto to discharge the ink to a nozzle;
an actuator positioned at an outer surface corresponding to the pressure chamber to provide a discharging driving force of the ink to the pressure chamber; and
a manifold including a path discharging the ink by pressure generated within the pressure chamber generated by the actuator and then supplying the ink to the pressure chamber and being repeatedly expanded and contracted in a direction toward the pressure chamber to attenuate a residual pressure wave remaining in the pressure chamber.

7. The inkjet head of claim 6, wherein the path is formed to have a plurality of lines corresponding to the pressure chamber to supply the ink to the pressure chamber.

8. The inkjet head of claim 6, wherein the path is formed by communicating a plurality of path units with each other, the path unit including a sectional area expanding part whose sectional area is gradually expanded in a direction towards the pressure chamber and a sectional area contracting part whose sectional area is gradually contracted at one end of the sectional area expanding part.

9. The inkjet head of claim 8, wherein the sectional area expanding part and the sectional area contracting part are disposed to be symmetrical to each other based on the boundary therebetween.

10. The inkjet head of claim 8, wherein the path is formed by disposing the path units in a path direction in series and communicating them with each other.

11. An inkjet head, comprising:
an upper substrate formed with a pressure chamber storing ink introduced thereinto to discharge the ink to a nozzle;
an actuator positioned at one surface of the upper substrate corresponding to the pressure chamber to provide a discharging driving force of the ink to the pressure chamber;
a lower substrate including a nozzle communicating with the pressure chamber and formed for discharging the ink; and
a manifold formed on the upper substrate and including a path discharging the ink by pressure generated within the pressure chamber generated by the actuator and then supplying the ink to the pressure chamber and being repeatedly expanded and contracted in a direction toward the pressure chamber to attenuate a residual pressure wave remaining in the pressure chamber.

12. The inkjet head of claim 11, wherein the path is formed to have a plurality of lines corresponding to the pressure chamber to supply the ink to the pressure chamber.

13. The inkjet head of claim 11, wherein the path is formed by communicating a plurality of path units with each other, the path unit including a sectional area expanding part whose sectional area is gradually expanded in a direction towards the pressure chamber and a sectional area contracting part whose sectional area is gradually contracted at one end of the sectional area expanding part.

14. The inkjet head of claim 13, wherein the sectional area expanding part and the sectional area contracting part are disposed to be symmetrical to each other based on the boundary therebetween.

15. The inkjet head of claim 13, wherein the path is formed by disposing the path units in a path direction in series and communicating them with each other.
